(19) United States
(12) Patent Application Publication
(10) Pub. No.: US 2018/0352166 A1
(43) Pub. Date: Dec. 6, 2018

(54) VIDEO RECORDING BY TRACKING WEARABLE DEVICES

(71) Applicant: Silicon Constellations, Inc., Santa Clara, CA (US)

(72) Inventor: Bojan Silic, Sunnyvale, CA (US)

(21) Appl. No.: 15/994,995

(22) Filed: May 31, 2018

Related U.S. Application Data
(60) Provisional application No. 62/514,002, filed on Jun. 1, 2017.
(60) Provisional application No. 62/525,603, filed on Jun. 27, 2017.

(51) Int. Cl. H04N 5/232; H04N 5/77

(52) U.S. Cl. CPC H04N 5/23296; H04N 5/23203; H04N 5/77

(57) ABSTRACT

A video system captures media such as images and video by tracking wearable devices of users, for example, at live events such as a music concert. The video system may determine location of the wearable devices by using infrared signals, radio frequency, or ultrasound signals detected by sensors installed at a venue of an event. Based on the locations of wearable devices and cameras, the video system generates commands to adjust orientation of one or more of the cameras to target a specific user for capturing video or images. For instance, a pan-tilt-zoom camera may be adjusted along multiple axis. The video system may notify users that video recording is ongoing, or that recording will start soon, by transmitting a command to wearable devices to emit a pattern of visible light.

### CROSS REFERENCE TO RELATED APPLICATIONS

This application claims the benefit of U.S. Provisional Application No. 62/514,002, filed on Jun. 1, 2017, and U.S. Provisional Application No. 62/525,603, filed on Jun. 27, 2017, both of which are incorporated herein by reference in their entirety for all purposes.

### BACKGROUND

Client devices such as smartphones allow users to capture images or videos in a variety of locations including live events such as concerts, sports games, or festivals. However, live events are often crowded environments, which makes it difficult for attendees to capture images or videos of themselves (for example, “selfies”) or their friends due to poor lighting or noise. Video cameras that are manually operated by crew members may be stationed at events, but these video cameras typically capture videos for the events in general, instead of videos targeted to individual attendees. In addition, at concerts or sports games, the video cameras are focused on performers such as artists or athletes. Since attendees may want to document or share their experiences at live events, it is desirable for the attendees to have a way to conveniently capture videos of images of themselves at the live events.

### BRIEF DESCRIPTION OF THE FIGURES

FIG. 1 illustrates a system environment for a video system, according to an embodiment.

FIG. 2 illustrates an example block diagram of a video system, according to an embodiment.

FIG. 3 illustrates an example process for capturing video, according to an embodiment.

FIG. 4A is a diagram of cameras of a video system at a venue, according to an embodiment.

FIG. 4B is another diagram of the cameras shown in FIG. 4A, according to an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

A video system captures media such as images and video by tracking wearable devices of users. In some embodiments, a wearable device includes light-emitting diodes (LEDs) that emit visible light and/or infrared (IR) LEDs. The video system may determine location of the wearable device using infrared signals from the wearable device that are detected by infrared sensors. The video system may also use a real-time locating system (RTLS) with a form of radio frequency or acoustic, e.g., ultrasound, communication. Further, LEDs of the wearable device may emit visible light signals to indicate to users that the video system is capturing video of the users. The video system may associate recorded video of a user with an online account of the user. This system may be used at live events (also referred to herein as “events”) such as, a concert, sports game, festival, or other types of gatherings. These events may be held at venues such as a stadium, fairground, convention center, park, or other types of indoor or outdoor (or combination of indoor and outdoor) locations suitable for holding a live event.

Example System Overview

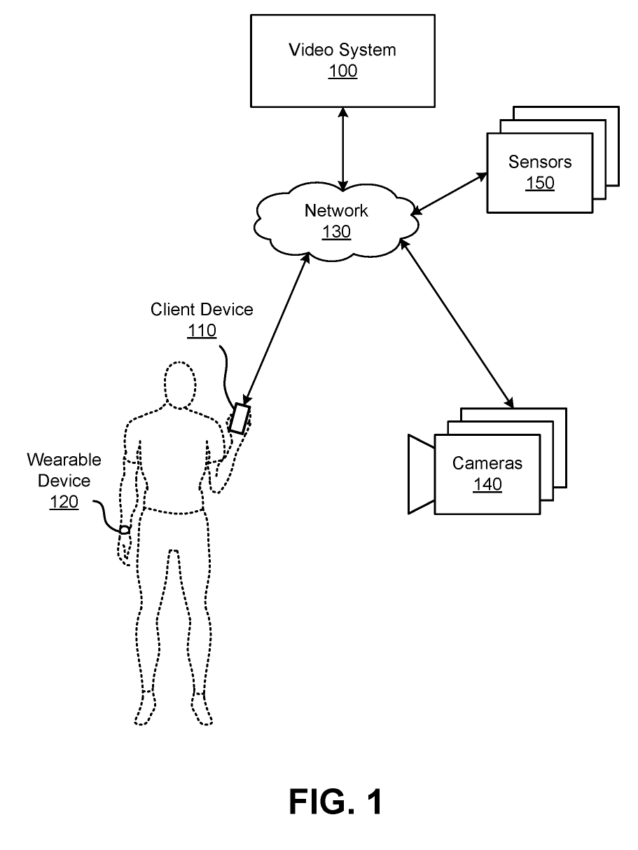

Figure (FIG.) 1 illustrates a system environment for a video system 100 according to an embodiment. The system environment shown in FIG. 1 includes the video system 100, client device 110, one or more cameras 140, and one or more sensors 150, which may be connected to each other via a network 130 (e.g., the Internet or a local area network connection). The system environment also includes wearable device 120, which may optionally be connected to the network 130. In other embodiments, different or additional entities can be included in the system environment. Though one client device 110 and one wearable device 120 (e.g., of a same user) are shown in FIG. 1, the system environment may include any number of client devices 110 and wearable devices 120 for any number of other users. In practice, the video system 100 may track, for example, thousands to tens of thousands or more devices at an event that draws large numbers of attendees (e.g., users). The functions performed by the various entities of FIG. 1 may vary in different embodiments.

A client device 110 comprises one or more computing devices capable of processing data as well as transmitting and receiving data over the network 130. For example, the client device 110 may be a mobile phone, a tablet computing device, an Internet of Things (IoT) device, augmented reality, virtual reality, or mixed reality device, a laptop computer, or any other device having computing and data communication capabilities. The client device 110 includes a user interface for presenting information, for example, visually using an electronic display or via audio played by a speaker. Additionally, the client device 110 may include one or more sensors such as a camera to capture images or video. The client device 110 includes a processor for manipulating and processing data, and a storage medium for storing data and program instructions associated with various applications. The storage medium may include both volatile memory (e.g., random access memory) and non-volatile storage memory such as hard disks, flash memory, and external memory storage devices.

A wearable device 120 is configured to be worn by a user of the video system 100, e.g., at an event. Each wearable device 120 includes one or more controllable lighting sources such as LEDs. For instance, the wearable device 120 may include at least one LED that emits visible light and at least one LED (or another type of lighting source) that emits non-visible light, e.g., infrared light. In addition, the wearable device 120 may include a RGB or RGBW LED that emits red, green, blue, white light, or any combination thereof to emit light having other types of colors. In some embodiments, wearable devices 120 devices emit unique patterns of light such that the video system 100 can distinguish wearable devices 120 from each other. Emitted light may be distinguishable by attributes such as intensity, color, or timing of the patterns of light. For example, a first pattern of light has a short pause and a second pattern of light has a long pause. The video system 100 may extract information from the pattern of light, e.g., the short pause encodes a “1” and the long pause encodes a “0.” Wearable devices 120 may have different types of form factors including, e.g., a wristband, bracelet, armband, headband, glow stick, necklace, garment, among other types of form factors suitable to be worn by a user. The form factor or configuration of LEDs may be customized based on a type of event attended by a user of the wearable device 120. In some embodiments, wearable devices 120 include other types of circuitry for RTLS, e.g., components for emitting radio frequency or acoustic signals.

The video system 100 may be communicatively coupled to a wearable device 120 over the network 130 or indirectly via a client device 110. For instance, the video system 100 may be connected to a client device 110 over the network 130, e.g., WIFI, and the client device 110 is connected to the wearable device 120 using the same or a different type of connection, e.g., BLUETOOTH® or another type of short-range transmission. Thus, the wearable device 120 may receive instructions from the video system 100, or from the client device 110 (e.g., based on information from the video system 100), to emit certain signals of light using one or more of the LEDs.

The cameras 140 capture media data including one or more of images (e.g., photos), video, audio, or other suitable forms of data. The cameras 140 may receive instructions from the video system 100 to capture media data, and the cameras 140 provide the captured media data to the video system 100. Cameras 140 may also include an onboard digital video recorder, local memory for storing captured media data, or one or more processors to pre-process media data. In some embodiments, camera 140 is coupled to a movable base to change the orientation or position of the camera 140. For example, a camera 140 is a pan-tilt-zoom (PTZ) type of camera. The movable base may adjust, e.g., using a programmable servo motor or another suitable type of actuation mechanism, the orientation or position to target a field of view of the camera 140 on at least one user or section of event venue. For example, an orientation of the camera 140 is adjusted over or more axis (e.g., pan axis, tilt axis, or roll axis) by a certain degree amount or to a target bearing. Additionally, the camera 140 can adjust a level of zoom to focus the field of view on a target. As an example configuration, twenty-eight cameras 140 can capture 10,000 video clips an hour, where a video clip is about ten seconds in duration.

The sensors 150 detect signals emitted by devices such as client devices 110 and wearable devices 120 for tracking location or movement of the devices based on the signals from the wearable devices 120. The sensors 150 may detect signals simultaneously (or separately) from a client device 110 and a wearable device 120 of a user. In some use cases, the sensors 150 detect light emitted by the wearable devices 120. In embodiments where the wearable devices 120 include LEDs that emit infrared light, the sensors 150 include at least an infrared sensor or camera. In other embodiments, the sensors 150 may detect other types of light (visible or non-visible), radio frequency such as ultra-wideband, acoustic signals such as ultrasound, or electromagnetic radiation. The sensors 150 may be positioned at one or more locations at an event for users of the video system 100. For instance, the sensors 150 are mounted onto walls, posts, or other structures of a stadium. As another example, the sensors 150 may be mounted to a stage of a concert venue. In some embodiments, a sensor 150 can track position of a device without requiring line-of-sight between the sensor 150 and the device, e.g., when the signal emitted by the wearable device 120 for tracking can travel through or around obstacles. A sensor 150 may operate “out-of-band” with the cameras 140 in that tracking of wearable devices 120 can be performed independently with video capture. Sensors 150 may have a wide angle lens to cover a wider portion of a venue for location tracking. Sensors 150 with overlapping fields of view may be used to cover hard-to-reach areas at a venue.

In some embodiments, the sensor 150 is coupled to the camera 140. For example, a video camera 140 has an infrared type of sensor 150 mounted coaxially (or with an offset) with a lens of the video camera 140. Therefore, the center of a field of view of the infrared sensor 150 may be the same (or within a threshold difference) to the center of a field of view of the camera 140, e.g., when controlled together by a movable base.

Example Video System

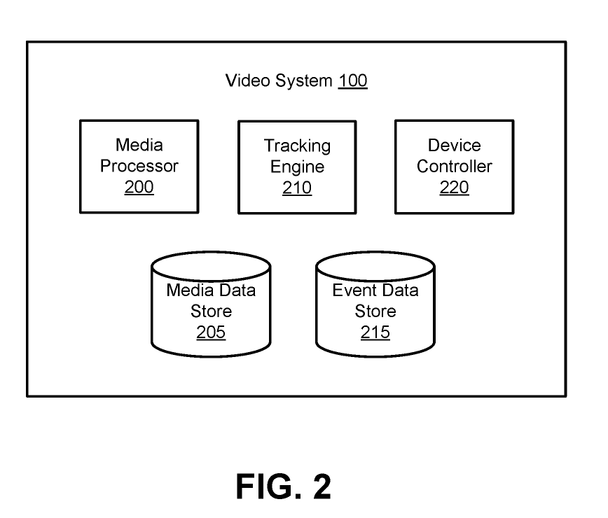

FIG. 2 illustrates an example block diagram of the video system 100 according to an embodiment. In an embodiment, the video system 100 includes a media processor 200, media data store 205, tracking engine 210, event data store 215, and device controller 220. Alternative embodiments may include different or additional modules or omit one or more of the illustrated modules.

The media processor 200 receives media data captured by cameras 140. In addition, the media processor 200 may perform any number of image processing or video processing techniques known to one skilled in the art, for example, noise reduction, auto-focusing, motion compensation, object detection, color calibration or conversion, cropping, rotations, zooming, detail enhancement, among others. The media processor 200 stores media data in the media data store 205 and may associate one or more attributes with media data for storage. The attributes describe context of content of media data, for example, user information of at least one user in a captured image or video, a location of a captured user, event information of a live event at which the media data was captured, or a timestamp. The media processor 200 may receive the user information from a social networking profile of a user. The media processor 200 may retrieve the event information from the event data store 215.

The event data store 215 may store event information such as a type of event being held at a venue, a capacity for the venue, expected attendance for an event, lighting information, time and location of an event, among other types of information describing events or venues. Additionally, the event data store 215 may store locations of one or more cameras 140 or sensors 150. In some embodiments, the event data store 215 stores locations of landmarks of a venue such as an entrance, exit, stage, backstage, concessions area, booth, restrooms, VIP area, etc. A given location or landmark may be defined by a geo-fence, e.g., a virtual perimeter.

In some embodiments, the media processor 200 generates content items using captured media. As an example use case, the media processor 200 generates a content item including an image or a portion of a video of a user at a live event. Moreover, the content item indicates the name and location of the live event. The media processor 200 may automatically post the content item to a social networking system. In another example, the media processor 200 may determine that a user is connected to another user on a social networking system, e.g., as a friend, family, co-worker, etc. Responsive to the determination, the media processor 200 may send a captured image or video of the user to a client device 110 of the other user.

The media processor 200 may incorporate audio tracks into a recorded video. For instance, the audio track is retrieved from a soundboard of a concert or from a previous sound recording. The media processor 200 may also provide images or videos for presentation on a display at a live event such as a jumbo screen, kiosk, or projector.

The tracking engine 210 determines locations of devices including one or more of client devices 110 or wearable devices 120 of users of the video system 100. In one embodiment, the tracking engine 210 sends an instruction to a wearable device 120 of a user to emit a signal such as a pattern of infrared light. The instruction may indicate one or more attributes for the infrared light, e.g., a frequency or amplitude of the infrared light. The tracking engine 210 identifies data captured by one of the sensors 150 (e.g., at the same event as the user and wearable device 120) within a threshold duration after the sending of the instruction. For instance, an infrared camera type of sensor 150 may have captured an infrared image of the infrared light emitted by the wearable device 120. The tracking engine 210 may use any number of techniques for image processing, e.g., blob detection to identify pixels or shapes of an image corresponding to imaged portions of infrared light. Responsive to the tracking engine 210 determining that the pattern of infrared light is present in one or more images, the tracking engine 210 may determine a location of the wearable device 120, e.g., relative to a particular venue.

In some embodiments, the tracking engine 210 sends an instruction to a client device 110 (in addition or alternate to the wearable device 120) of a user to emit a signal. In other embodiments, the wearable device 120 or client device 110 is configured to emit signals for device tracking without necessarily requiring continuous instructions from the video system 100. For instance, the wearable device 120 periodically emits a predetermined pattern of infrared light. Responsive to determining that an event has begun or that a wearable device 120 is located within a threshold proximity to a venue of the event, the tracking engine 210 may provide an instruction to the wearable device 120 to trigger the emitting of infrared light, e.g., for the remaining duration of the event or a portion thereof.

As an example use case, the tracking engine 210 determines that the wearable device 120 is located at a particular section, row, or seat of a stadium type of venue. The tracking engine 210 may use calibration data from the event data store 215 to determine the location of the wearable device 120. For example, the calibration data describes the position or sizes of the sections, rows, or seats of the stadium. Additionally, the calibration data may indicate position and orientation information of where cameras 140 are mounted at the stadium. Thus, the wearable device 120 can map a set of one or more pixels of an image (e.g., having X-Y coordinate points) to a location of the stadium, as well as map distances in the image to real-life distances. The wearable device 120 may also determine locations of devices in three dimensions, for instance, using the intensity of detected light or triangulation with multiple cameras 140 at different locations at the stadium. Moreover, the wearable device 120 may track motion of devices over a period of time using a sequence of timestamped images.

The device controller 220 controls wearable devices 120 or cameras 140 of the video system 100. The device controller 220 may send instructions to wearable devices 120 to transmit patterns of visible light. For example, an instruction causes a wearable device 120 to transmit a pattern of visible light simultaneously with capturing of video by a camera 140. As another example, an instruction causes a wearable device 120 to transmit a pattern of visible light for at least a period of time before capturing of video by a camera 140. Thus, the light may serve as an indication to a user of the wearable device 120 that video recording will start soon. The wearable device 120 may emit a pattern of light to indicate that video recording is about to end.

In some embodiments, the device controller 220 transmits instructions to one or more wearable devices 120 of other users at a live event and located within a threshold distance from the user. The instructions may cause the other wearable devices 120 to emit light simultaneously with capturing of video by a camera 140. Therefore, the video may capture particular lighting effects or patterns as result of controlling the wearable devices 120. For example, the instructions cause wearable devices 120 surrounding a user to emit a circular “halo” of light centered on the user, where the halo may pulse or expand in size. In other embodiments, LEDs of wearable devices 120 may each represent a pixel of an image such that light emitted from multiple adjacent wearable devices 120 can form the image when aggregated. In some use cases, the pattern device controller 220 determines the pattern of light based on a gesture performed by the user. The device controller 220 can determine gestures by processing motion data received from a wearable device 120, e.g., from an accelerometer, gyroscope, or inertial measurement unit. Accordingly, the device controller 220 may synchronize patterns of light with dance moves of the user or other types of gestures.

In some embodiments, the device controller 220 enhances auto-aiming of a camera 140 towards a target user or location using a camera 140 coupled with an infrared sensor 150. Responsive to the media processor 200 determining that a target user's wearable device 120 has entered a field of view of the infrared sensor 150, control of the camera 140 may be determined using images captured by the infrared sensor 150, e.g., until the target user is centered in a video recording of the camera 140. Thus, the video system 100 may determine movement or location of the wearable device (and thereby the target user) without analyzing the media data captured by the camera 140. In other configurations, the device controller 220 may use data from both the infrared sensor 150 and the camera 140 for controlling orientation or positioning of the camera 140.

In some embodiments, the device controller 220 manipulates a camera 140 using commands that may be pre-programmed or provided during run time. The commands instruct the camera 140 to perform operations, e.g., focus, pan, tilt, zoom, image flip, set exposure mode, etc. Additionally, the commands may be represented by a command packet indicating one or more parameters. For instance, a focus command includes a level of zoom or target resolution, which may be within a predetermined range or error. The device controller 220 may determine parameters using a calibration process. As an example, the device controller 220 stores zoom calibration values in the event data store 215 mapped to physical distances between a camera 140 and a target user on which to focus. Zoom calibration values may be associated with a particular camera 140 at a certain location within a venue. The device controller 220 may determine the zoom calibration values as a function of the physical distances. Further, the device controller 220 may retrieve stored calibration values during run time, which may reduce the time required to adjust cameras 140 relative to using other more resource-intensive video or image processing techniques.

Example Process Flow

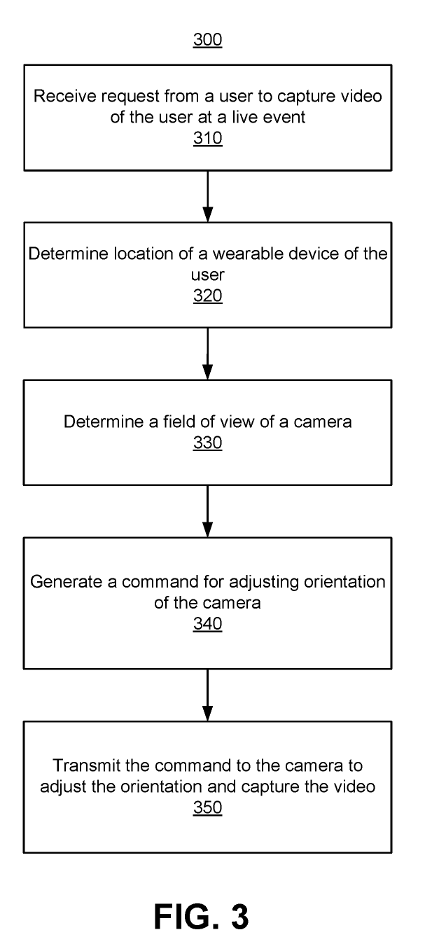

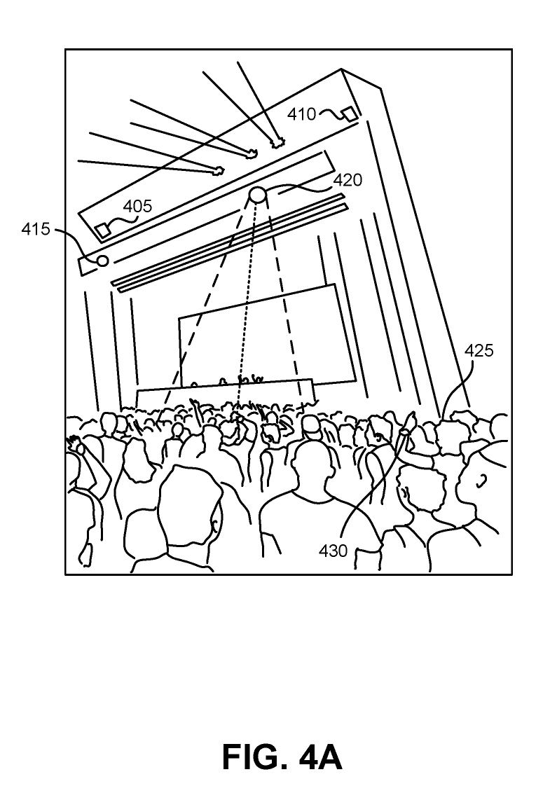

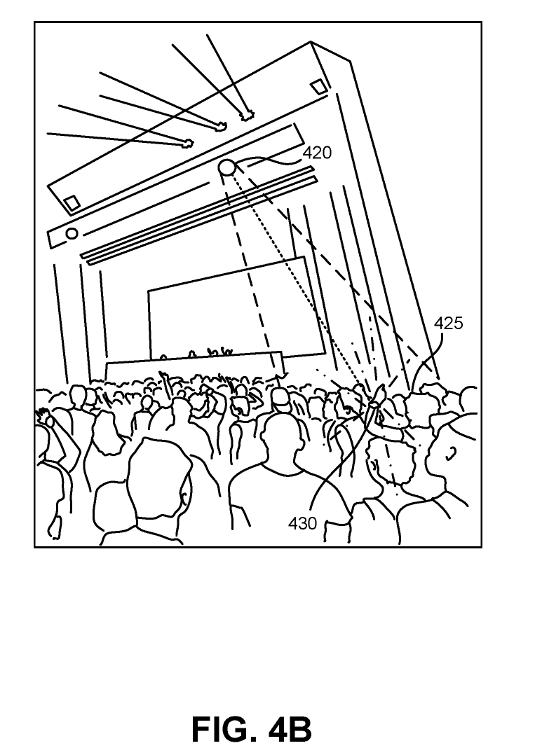

FIG. 3 illustrates an example process 300 for capturing video, according to an embodiment. The process 300 may include different or additional steps than those described in conjunction with FIG. 3 in some embodiments or perform steps in different orders than the order described in conjunction with FIG. 3. Steps of the process 300 are further described below with reference to the example diagrams shown in FIGS. 4A-B. For purposes of explanation, the following example use case describes a concert type of live event, though the embodiments described herein may be adapted for systems and methods for capturing media data (e.g., images of video) at other types of events or locations, e.g., not necessarily associated with a particular event.

FIG. 4A is a diagram of cameras of a video system at a venue, according to an embodiment. A user 425 at the venue has a wearable device 430. As illustrated in the example diagram, in addition to cameras 415 and 420, the venue also includes sensors 405 and 410 mounted on a structure of a stage for a concert.

The video system 100 receives 310 a request from the user 425 to capture video of the user at a live event. The video system 100 may receive the request from the wearable device 430 or a client device 110 of a user 425. For example, the wearable device 430 transmits the request responsive to the user 425 pressing a button or sensor (e.g., a user control) or another type of user input of the wearable device 430, e.g., a gesture detected based on motion data. As another example, the video system 100 receives the request via an application programming interface (API) or push notification associated with a third party, e.g., a social networking system. The request may be received with a hashtag, user information, or other identifying information about a device that provided the request, e.g., a serial number or ID of a wearable device 120. The video system 100 may parse the hashtag to determine that the request is for recording a video of the user.

In some embodiments, a wearable device 120 may be registered with the video system 100 and associated with a specific user. For instance, a user registers a wearable device 120 using an application of the video system 100 running on a client device 110. In some use cases, wearable devices 120 are registered at a distribution location such as a venue of a live event, or a vendor of the wearable devices 120. Additionally, wearable devices 120 may be registered via a social networking system, which may be a third party partner of an entity associated with the video system 100.

In some embodiments, the video system 100 maintains a queue of request for capturing media data. Since a live event may typically include more attendees than cameras 140, it may not necessarily be possible to record video targeted to each attendee simultaneously. Thus, the video system 100 can use the queue to determine an order to process requests. The order of the queue may be based on “first-in, first-out” system, though in some embodiments, the video system 100 may prioritize requests based on certain attributes (e.g., VIP status of a user or lighting conditions). As previously described with respect to the device controller 220, the video system 100 may notify a user that capture of video or an image is starting soon by transmitting an instruction to the user's wearable device 120 to emit a pattern of light.

The tracking engine 210 determines 320 location of the wearable device 430 of the user 425. In some embodiments, the tracking engine 210 uses sensor data from one or more sensors 150 to locate the wearable device 430. The tracking engine 210 may register (e.g., prior to the live event) the location of the cameras 415 and 420 as well as the sensors 405 and 410 in the event data store 215. In some embodiments, the tracking engine 210 uses triangulation with the sensor data and retrieved sensor locations to determine the location of wearable devices.

The tracking engine 210 determines 330 a field of view of the camera 420 at the live event. The field of view may be based on a location if the camera 420 as well as a configuration (e.g., orientation) of the camera 420. For example, the field of view changes as the camera 420 is adjusted on one or more axis, e.g., pan or tilt. Additionally, a zoom level of the field of view may be based on the location, e.g., how far or close is the camera 420 positioned relative to a target. The tracking engine 210 may retrieve registered locations of cameras 415 or 420 from the event data store 215. In addition to location information, the tracking engine 210 can also determine orientation of a camera. For example, in the embodiment shown in FIG. 4A, the camera 420 is oriented to capture video data of users in the crowd of attendees at the concert.

The device controller 220 generates 340 a command for adjusting orientation of the camera 420 using the location of the wearable device 430. The command may cause the camera to be adjusted on at least one axis such that the user 425 is in the field of view of the camera 420. The device controller 220 transmits 350 the command to the camera 420 to adjust the orientation and capture the video of the user 425 responsive to the request. The command may also indicate a level of zoom suitable for capturing the video based on the location of the wearable device 430 or recording camera 420.

FIG. 4B is another diagram of the cameras shown in FIG. 4A, according to an embodiment. In the example illustrated in FIGS. 4A-B, responsive to receiving the generated command from the device controller 220, the camera 420 changes orientation to target the user 425 who requested capture of video. In particular, a center of a field of view of the camera 420 may be directed at the wearable device 430 of the user 425. Moreover, the device controller 220 may send another command to cause the wearable device 430 to emit a pattern of light while the camera 420 is recording video of the user 425. In some embodiments, the device controller 220 generates and sends updated commands responsive to tracking movement of the wearable device 120. For example, as the user 425 waves an arm wearing the wearable device 430 or walks around the venue, a recording camera 420 can follow the user 425 in real time, and thus keep the user in the field of view.

In some embodiments, the device controller 220 may select one of multiple cameras 140 to record video based on proximity to the location of the requesting user. Additionally, the device controller 220 may transmit commands to multiple cameras 140 to simultaneously record video at different perspectives of a target user. In other embodiments, the device controller 220 sends the locations of wearable devices 120 to a camera 140, and the camera 140 uses a local processor (e.g., instead of a server of the video system 100) to determine appropriate commands for adjusting the camera 140 toward a target user.

Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product including a computer-readable non-transitory medium containing computer program code, which can be executed by a computer processor for performing any or all of the steps, operations, or processes described.

Embodiments of the invention may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for recording videos at live events, the method comprising:
receiving a request from a user to capture video of the user at a live event;
determining a location of a wearable device of the user by detecting signals emitted by the wearable device;
determining a field of view of a camera positioned at the live event;
generating, using the location, a command for causing orientation of the camera to be adjusted on at least one axis such that the user is in the field of view of the camera; and
transmitting the command to the camera to adjust the orientation of the camera and capture the video of the user responsive to the request.

2. The method of claim 1, further comprising:
transmitting instructions to the wearable device to emit a pattern of visible light simultaneously with capturing of the video by the camera.

3. The method of claim 1, further comprising:
transmitting instructions to the wearable device to emit a pattern of visible light for at least a period of time before capturing of the video by the camera.

4. The method of claim 1, further comprising:
transmitting instructions to one or more wearable devices of other users at the live event located within a threshold distance from the user, the instructions for emitting a pattern of visible light simultaneously with capturing of the video by the camera.

5. The method of claim 4, further comprising:
receiving motion data from the wearable device;
determining a gesture performed by the user by processing the motion data; and
determining the pattern of visible light based on the gesture.

6. The method of claim 1, wherein the signals emitted by the wearable device is infrared (IR) light transmitted by an infrared light-emitting device (LED) of the wearable device, and wherein the signals are detected by at least one infrared sensor.

7. The method of claim 1, wherein the signals emitted by the wearable device include ultra-wideband signals.

8. The method of claim 1, wherein the command causes orientation of the camera to be adjusted on a pan axis and a tilt axis, and wherein the command causes the camera to modify a level of zoom to focus the field of view on the user.

9. The method of claim 1, wherein the request is received from the wearable device responsive the user interacting with a user control of the wearable device.

10. The method of claim 1, wherein the request is received from a client device of the user via an application programming interface or push notification.

11. The method of claim 1, further comprising:
determining that the user is connected to another user on a social networking system; and
sending the captured video of the user to a client device of the another user.

12. The method of claim 1, further comprising:
determining user profile information of the user on a social networking system; and
generating a content item on the social networking system using the captured video, the user profile information, and information describing the live event.

13. A method for capturing images at live events, the method comprising:
receiving a request from a user to capture an image of the user at a live event;
determining a location of a wearable device of the user by detecting signals emitted by the wearable device;
determining a field of view of a camera positioned at the live event;
generating, using the location, a command for causing orientation of the camera to be adjusted on at least one axis such that the user is in the field of view of the camera; and
transmitting the command to the camera to adjust the orientation of the camera and capture the image of the user responsive to the request.

14. The method of claim 13, wherein the command causes orientation of the camera to be adjusted on a pan axis and a tilt axis, and wherein the command causes the camera to modify a level of zoom to focus the field of view on the user.

15. A non-transitory computer-readable storage medium storing instructions for image processing, the instructions when executed by a processor causing the processor to perform steps including:
receiving a request from a user to capture video of the user at a live event;
determining a location of a wearable device of the user by detecting signals emitted by the wearable device;
determining a field of view of a camera positioned at the live event;
generating, using the location, a command for causing orientation of the camera to be adjusted on at least one axis such that the user is in the field of view of the camera; and
transmitting the command to the camera to adjust the orientation of the camera and capture the video of the user responsive to the request.

16. The non-transitory computer-readable storage medium of claim 15, the instructions when executed by the processor causing the processor to perform further steps including:
transmitting instructions to the wearable device to emit a pattern of visible light simultaneously with capturing of the video by the camera.

17. The non-transitory computer-readable storage medium of claim 15, the instructions when executed by the processor causing the processor to perform further steps including:
transmitting instructions to the wearable device to emit a pattern of visible light for at least a period of time before capturing of the video by the camera.

18. The non-transitory computer-readable storage medium of claim 15, the instructions when executed by the processor causing the processor to perform further steps including:
transmitting instructions to one or more wearable devices of other users at the live event located within a threshold distance from the user, the instructions for emitting a pattern of visible light simultaneously with capturing of the video by the camera.

19. The non-transitory computer-readable storage medium of claim 18, the instructions when executed by the processor causing the processor to perform further steps including:
receiving motion data from the wearable device;
determining a gesture performed by the user by processing the motion data; and
determining the pattern of visible light based on the gesture.

20. The non-transitory computer-readable storage medium of claim 15, wherein the command causes orientation of the camera to be adjusted on a pan axis and a tilt axis, and wherein the command causes the camera to modify a level of zoom to focus the field of view on the user.
